(19) United States
(12) Patent Application Publication
(10) Pub. No.: US 2014/0136740 A1
(43) Pub. Date: May 15, 2014

(54) INPUT-OUTPUT CONTROL UNIT AND FRAME PROCESSING METHOD FOR THE INPUT-OUTPUT CONTROL UNIT

(71) Applicants: Hideaki Monji, Tokyo (JP); Yusaku Kiyota, Tokyo (JP)

(72) Inventors: Hideaki Monji, Tokyo (JP); Yusaku Kiyota, Tokyo (JP)

(73) Assignee: Hitachi, Ltd., Tokyo (JP)

(21) Appl. No.: 14/129,488

(22) PCT Filed: Jun. 29, 2011
(86) PCT No.: PCT/JP2011/003739

§ 371 Date: Dec. 26, 2013

(51) Int. Cl. G06F 13/42

(52) U.S. Cl. CPC G06F 13/42
USPC 710/106

(57) ABSTRACT

An input-output control unit includes: an interface control circuit for controlling data on a frame basis with respect to each of transmitted and received frames; a reception buffer control circuit for transferring receive-data stored in a receive-data buffer to a command issuer; a transmission buffer control circuit for transferring send-data stored in a send-data buffer to an interface; a plurality of protocol control circuits for controlling transfer of the receive-data and the send-data; and a received frame routing control circuit for selecting a location to which the received frame should be assigned, from among the plurality of protocol control circuits, based on control information attached to the received frame received by the interface control circuit and assigning processing on the received frame to the selected protocol control circuit.

### TECHNICAL FIELD

The present invention relates to an input-output control unit for sending and receiving data in a computer system and a frame processing method for the input-output control unit.

### BACKGROUND ART

Rapid technological progress has been made in the field of ultra-high-speed data links. There is a demand for a further increase in speeds of mutual network connections between computers and input/output (I/O) devices in computer systems and Fibre Channel (FC) is selected as an inexpensive mutual connection means suited for practical use.

Moreover, mechanisms that use PCI (Peripheral Component Interconnect) developed by PCI-SIG have been being widely used as a means for connecting the Fibre Channel and host processors and various companies are supplying Fibre Channel HBAs (Host Bus Adapters) to the market.

In the HBA market in recent years, host systems that reduce TCO (Total Cost of Ownership) by sharing one HBA with a plurality of guest OS's (Operating Systems) have become widespread with the rise of a virtualization technique and cloud computing and the demand for enforcement of HBA's performance (the number of transactions per unit time) along with an increase in loads on the network due to sharing has been increasing dramatically.

In order to enhance the HBA's performance, for example, a method of accumulating a plurality of completely independent Fibre Channel control circuits in one LSI (Large Scale Integrated circuit) is reported (see Patent Literature 1). Patent Literature 1 refers to a method of having one protocol control circuit execute processing on frames sent and received by a plurality of Fibre Channel ports.

### CITATION LIST

### Patent Literature

[Patent Literature 1] Japanese Patent Application Laid-Open (Kokai) Publication No. 2009-223918

### SUMMARY OF INVENTION

### Problems to be Solved by the Invention

However, if the method described in Patent Literature 1 is employed, the load on the protocol control circuit may increase along with an increase in the number of transactions.

In this case, processing performance can be enhanced by increasing an operating frequency of the protocol control circuit. However, there are technical limitations to the enhancement of the operating frequency of the protocol control circuit and it is difficult to satisfy performance required for the protocol control circuit only by this method.

Moreover, it is possible to mount protocol control circuits on a plurality of Fibre Channel ports on a one-on-one basis as another means of performance enhancement. If this method is employed, it is possible to control processing on frames sent and received by the plurality of Fibre Channel ports without increasing loads on the protocol control circuits.

However, if a Fibre Channel port with a light load exists, load on processing of the protocol control circuit for controlling that Fibre Channel port is also reduced. Consequently, idle time for some protocol control circuits will increase and the plurality of protocol control circuits will no longer be able to use the idle time effectively as a whole.

The present invention was devised in light of the above-described problems of the conventional art and it is an object of the invention to provide an input-output control unit capable of assigning a plurality of received frames to a plurality of protocol control units and executing processing on the plurality of received frames in parallel and a frame processing method for such an input-output control unit.

### Means for Solving the Problems

In order to achieve the above-described object, the present invention is characterized in that it includes: one or more interface control circuits for controlling data sent to, and received from, an access target of a command issuer on a frame basis with respect to each of transmitted and received frames; a reception buffer control circuit for storing receive-data of the received frame, from among the transmitted and received frames which are sent and received by the interface control circuit, in a receive-data buffer and transferring the receive-data stored in the receive-data buffer to the command issuer; a transmission buffer control circuit for storing send-data sent from the command issuer in a send-data buffer and transferring the send-data stored in the send-data buffer to the interface; a plurality of protocol control circuits for controlling the reception buffer control circuit with respect to transfer of the receive-data and controlling the transmission buffer control circuit with respect to transfer of the send-data; and a received frame routing control circuit for selecting a location to which the received frame should be assigned, from among the plurality of protocol control circuits, based on control information attached to the received frame among the transmitted and received frames sent and received by the interface control circuit and assigning processing on the received frame to the selected protocol control circuit.

### Advantageous Effects of Invention

According to the present invention, it is possible to assign a plurality of received frames to a plurality of protocol control units and execute processing on the plurality of received frames in parallel.

### BRIEF DESCRIPTION OF DRAWINGS

FIG. 1 is an overall configuration diagram of a computer system that uses input-output control units according to the present invention.

FIG. 2 is a block diagram of the input-output control unit according to the present invention.

FIG. 3 is a configuration diagram of a Fibre Channel frame.

FIG. 4 is a format configuration diagram of an FC-PH header in the Fibre Channel frame.

FIG. 5 is a format configuration diagram of an exchange number.

FIG. 6 is an operation explanatory diagram when the input-output control unit operates as an originator.

FIG. 7 is an operation explanatory diagram when the input-output control unit operates as a responder.

FIG. 8 is a block diagram of a received frame routing control circuit.

FIG. 9 is a flowchart for explaining the operation of the received frame routing control circuit.

### DESCRIPTION OF EMBODIMENTS

### Embodiment

This embodiment is designed to select a location to which a received frame should be assigned, from among a plurality of protocol control circuits based on control information attached to the received frame, which is received by the interface control circuit, and assign processing on the received frame to the selected protocol control circuit.

Moreover, this embodiment is an example of a case in which the present invention is applied to the input-output control unit having four protocol control circuits for four Fibre Channel ports; however, the number of protocol control circuits for Fibre Channel ports is not limited to this embodiment.

An embodiment of the present invention will be explained with reference to drawings.

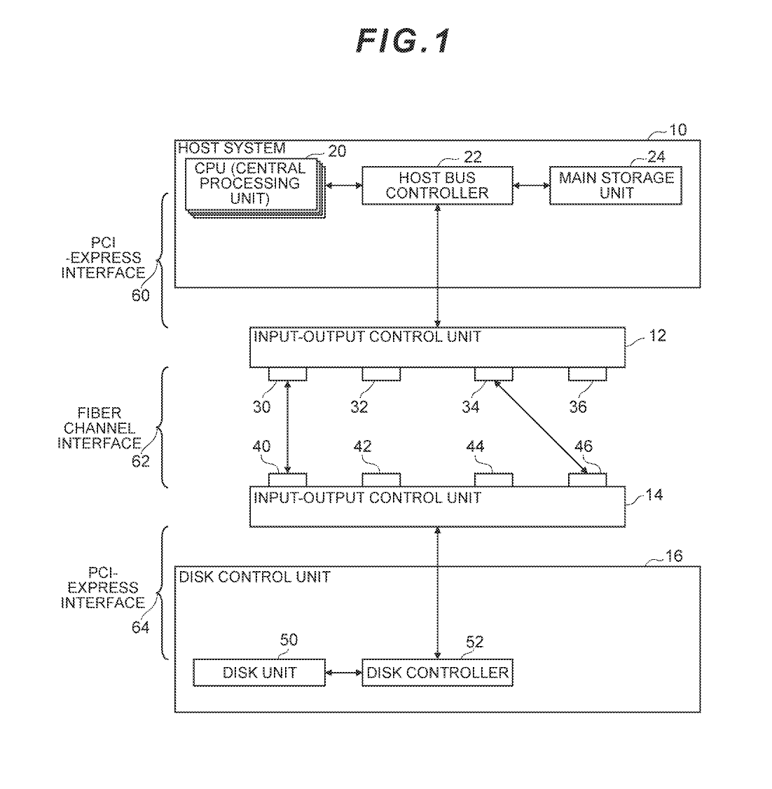

FIG. 1 is a system configuration diagram of a computer system equipped with input-output control units according to the present invention.

Referring to FIG. 1, the computer system includes a host system 10, input-output units 12, 14, and a disk control unit 16.

The host system 10 includes one or more CPUs (central processing units) 20, a host bus controller 22, and a main storage unit 24 and becomes a command issuer.

The CPU 20 is configured as a processor for supervising and controlling the entire host system 10 in accordance with processing programs. The main storage unit 24 is configured as a data storage area for storing various data. The host bus controller 22 controls data transfer between the CPU 20 and the main storage unit 24, data transfer between the input-output control unit 12 and the CPU 20, or data transfer between the input-output control unit 12 and the main storage unit 24. For example, a PCI-express interface 60 is configured as an interface between the host bus controller 22 and the input-output control unit 12.

The input-output control unit 12 is a device for sending data to, and receiving data from, the host system 10 or the input-output control unit 14 and is equipped with four ports (input/output ports) 30, 32, 34, 36. The input-output control unit 14 is a device for sending data to, and receiving data from, the input-output control unit 12 or the disk control unit 16 and is equipped with four ports (input/output ports) 40, 42, 44, 46. The ports 30 to 36 and the ports 40 to 46 are provided with, for example, optical transceivers and data are sent and received between the respective ports via the optical transceivers. In this case, for example, a Fibre Channel interface 62 is configured as an interface between the input-output control unit 12 and the input-output control unit 14.

The disk control unit 16 is a device for sending data to, and receiving data from, the input-output control unit 14, includes a disk unit 50 and a disk controller 52, and becomes an access target of the command issuer (the host system 10).

For example, a PCI-express interface 64 is configured as an interface between the disk control unit 16 and the input-output control unit 14.

The disk unit 50 includes a plurality of storage devices such as HDDs (Hard Disk Drives). The disk controller 52 controls data input to and output from the disk unit 50. The disk controller 52 is connected to the input-output control unit 14.

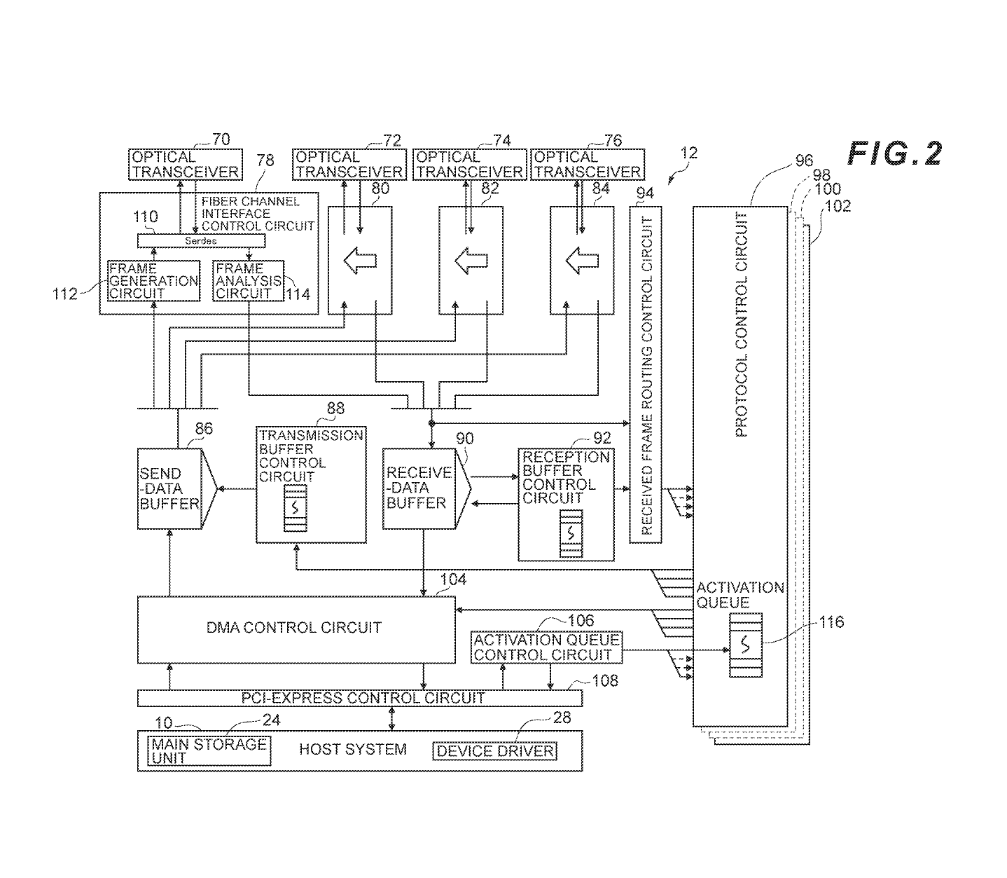

Next, FIG. 2 shows a block diagram of the input-output control unit 12.

Referring to FIG. 2, the input-output control unit 12 includes optical transceivers 70, 72, 74, 76, Fibre Channel interface control circuits 78, 80, 82, 84, a send-data buffer 86, a transmission buffer control circuit 88, a receive-data buffer 90, a reception buffer control circuit 92, a received frame routing control circuit 94, four protocol control circuits 96, 98, 100, 102, a DMA (Direct Memory Access) control circuit 104, an activation queue control circuit 106, and a PCI-express control circuit 108.

The optical transceivers 70 to 76 are located at the ports 30 to 36, respectively, and send data (frames) to, and receive data (frames) from, the optical transceivers located at the ports 40 to 46 of the input-output control unit 14.

The Fibre Channel interface control circuit 78, 80, 82, 84 includes a serializer/deserializer (Serdes) 110, a frame generation circuit 112, and a frame analysis circuit 114 and is configured as an interface circuit for controlling data sent to and received from the access target of the command issuer on a frame basis with respect to each of transmitted and received frames.

Incidentally, each Fibre Channel interface control circuit 78, 80, 82, 84 has the same configuration, so that only the Fibre Channel interface control circuit 78 will be explained below.

The serializer/deserializer (Serdes) 110 converts serial data attached to a received frame, which is received by the optical transceiver 70, into parallel data, outputs the converted parallel data to the frame analysis circuit 114, and outputs a transmitted frame, which is sent from the frame generation circuit 112, to the optical transceiver 70.

The frame generation circuit 112 generates a frame header of the transmitted frame based on send-data sent from the send-data buffer 86, attaches the send-data to the generated frame header, and outputs the transmitted frame, to which the send-data and the frame header are attached, to the serializer/deserializer (Serdes) 110.

The frame analysis circuit 114 recognizes an order set from the parallel data converted by the serializer/deserializer (Serdes) 110 and executes processing for, for example, frame assembling and error detection using CRC (Cyclic Redundancy Check), has the processing results reflected in the received frame, and outputs the received frame, in which the processing results are reflected, to the receive-data buffer 90.

The send-data buffer 86 is a send-data buffer, which is common to the Fibre Channel interface control circuits 78 to 84, and stores the send-data sent from the DMA control circuit 104. The transmission buffer control circuit 88 controls transfer of the send-data in the send-data buffer 86 to any one Fibre Channel interface control circuit of the Fibre Channel interface control circuits 78 to 84 based on an instruction from any one protocol control circuit of the protocol control circuits 96 to 102.

The receive-data buffer 90 is a receive-data buffer, which is common to the Fibre Channel interface control circuits 78 to 84, and stores the receive-data attached to the received frame which is received by the optical transceivers 70 to 76. The reception buffer control circuit 92 controls transfer of the receive-data stored in the receive-data buffer 90 to the DMA control circuit 40 and notifies a buffer address of the received frame stored in the receive-data buffer 90 of the protocol control circuits 96 to 102 via the received frame routing control circuit 94 by means of the interrupt processing.

The received frame routing control circuit 94 identifies control information attached to the received frame which is output from the Fibre Channel interface control circuit 78 to 84 and executes routing control to decide any one protocol control circuit of the four protocol control circuits 96 to 102 as the location to which the received frame should be assigned.

The protocol control circuit 96 to 102 controls the reception buffer control circuit 92 with respect to transfer of the receive-data and also controls the transmission buffer control circuit 88 with respect to transfer of the send-data. Moreover, each protocol control circuit 96 to 102 is equipped with an activation queue 116 for stacking activation commands from the activation queue control circuit 106.

The protocol control circuit 96 to 102 executes processing in accordance with an activation command stacked in the activation queue 116 included in each protocol control circuit 96 to 102. For example, if a write command is stacked in the activation queue 116 of the protocol control circuit 96, the protocol control circuit 96 outputs an instruction to the DMA control circuit 104 and the transmission buffer control circuit 88 to send the transmitted frame. Similarly, when a command is stacked in the activation queue 116 of each protocol control circuit 98 to 102, the protocol control circuit 98 to 102 outputs an instruction to the DMA control circuit 104 and the transmission buffer control circuit 88 to send the transmitted frame.

On the other hand, if the received frame routing control circuit 94 decides the location to which the received frame should be assigned, the protocol control circuit to which the received frame is assigned, among the protocol control circuits 96 to 102, executes processing for designating the location to store data in the main storage unit 24 to the DMA control circuit 104 based on the buffer address reported from the reception buffer control circuit 92 by means of an interrupt.

The DMA control circuit 104 controls transmission of transmitted frames from the bus control circuit 108 such as a PCI-express control circuit to the send-data buffer 86 and also controls transmission of received frames sent from the receive-data buffer 90 to the PCI-express control circuit 108. If any one protocol control circuit of the protocol control circuits 96 to 102 issues an instruction to send a received frame under this circumstance, the DMA control circuit 104 reads the designated received frame from the receive-data buffer 90 and sends the received frame, which has been read, to the PCI-express control circuit 108.

The PCI-express control circuit 108 mediates the received frame or the transmitted frame sent or received between the host system 10 and the DMA control circuit 104, sends an activation command, which is sent from the device driver 28 for the host system 10, to the activation queue control circuit 106, and outputs the status of the activation queue 116 to the host system 10 via the PCI-express control circuit 108. Incidentally, the device driver 28 is configured by the CPU 20 executing a device processing program.

The input-output control unit 14 can be configured by using the same elements as those of the input-output control unit 12. Moreover, the input-output control unit 14 can be configured by excluding the received frame routing control circuit 94 from the elements constituting the input-output control unit 12 and using one protocol control circuit instead of using four protocol control circuits.

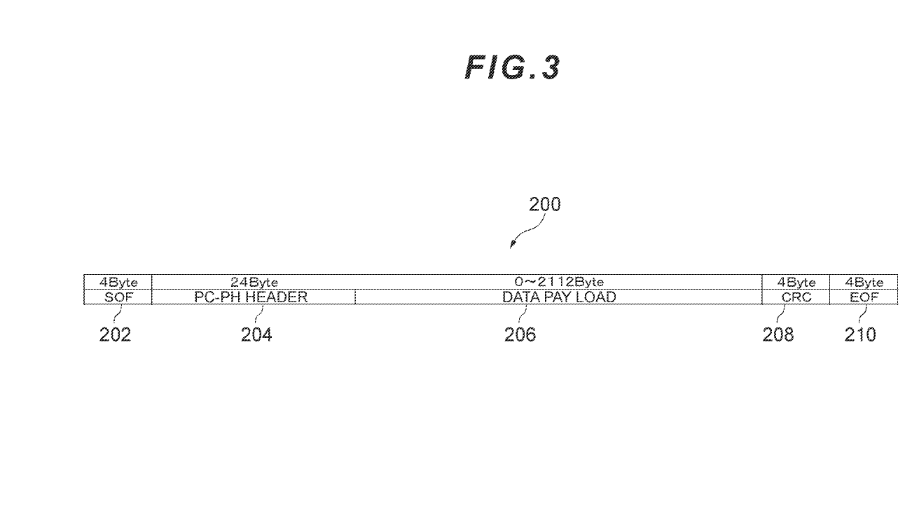

Next, FIG. 3 shows a configuration diagram of a Fibre Channel frame.

Referring to FIG. 3, the Fibre Channel frame 200 is configured as a received frame analyzed by each protocol control circuit 96 to 102. This Fibre Channel frame 200 is composed of a 4-byte SOF (Start Of Frame) 202, a 24-byte FC-PH (Fibre Channel Physical) header 204, a 0 to 2112-byte data pay load 206, a 4-byte CRC 208, and a 4-byte EOF (End Of Frame) 210.

Each of the SOF 202 and the EOF 210 is called a delimiter and is an order set for identifying a break in the Fibre Channel frame 200. The FC-PH header 204 is configured as control information for the Fibre Channel frame 200. The data pay load 206 is composed of data used by, for example, the host system 10. The CRC 208 is composed of data for error detection. Under this circumstance, the data pay load 206 is configured as data whose validity is guaranteed by using CRC.

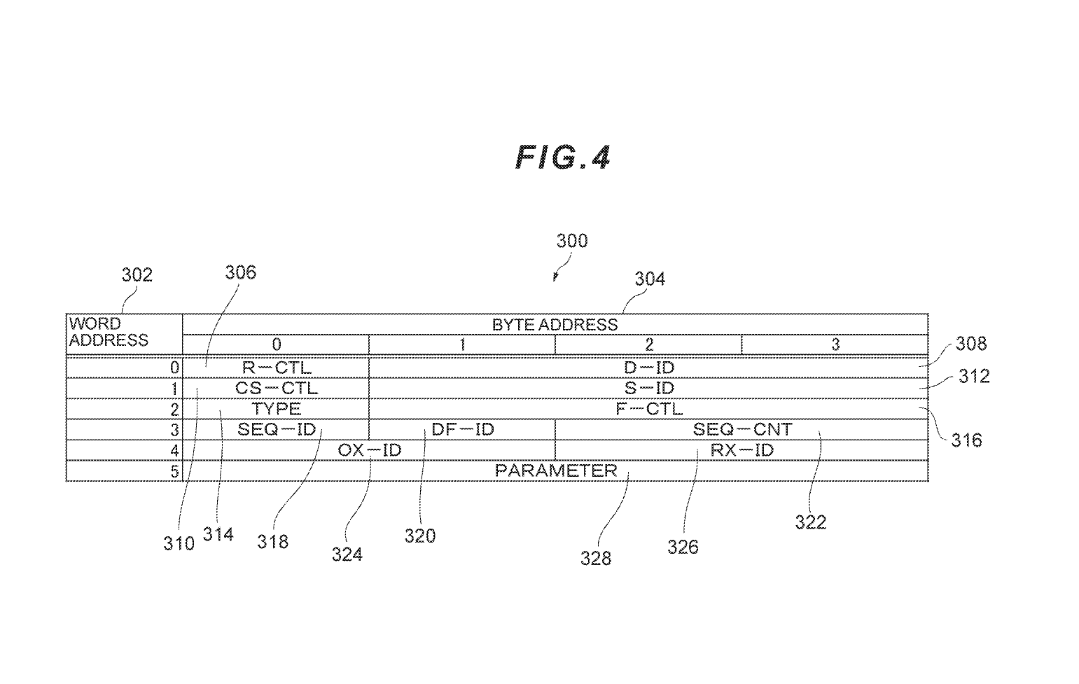

Next, FIG. 4 shows a format configuration diagram of the FC-PH header in the Fibre Channel frame.

Referring to FIG. 4, a format 300 of the FC-PH header in the Fibre Channel frame 200 is composed of a word address 302 and a byte address 304. “0” to “5” is assigned as an address to the word address 302 and “0” to “3” is assigned as an address to the byte address 304. Each address is associated with a plurality of fields 306 to 328.

The field 316 of these fields 306 to 328 is configured as F-CTL and this F-CTL includes a field called Exchange Context (hereinafter referred to as the E-C). When a frame sender operates as an originator, information “0” is assigned, as information for specifying the operation of the frame sender, to the E-C in the field 316; and if the frame sender operates as a responder, information “1” is assigned as operation information for specifying the operation of the frame sender to the E-C in the field 316.

If the Fibre Channel frame 200 is used as a transmitted or received frame here, a set of logical frames which are sent and received by one-time read/write operation between the host system 10 and the disk control unit 16 is called exchange; and according to the Fibre Channel, data transfer along with transmission and reception of such logical frames is performed by multiplex operation for each exchange.

So, this embodiment is designed so that each protocol control circuit 96 to 102 decides a unique number to be assigned to each exchange and the exchange number decided by each protocol control circuit is assigned to the FC-PH header in the Fibre Channel frame 200.

Specifically, the exchange number for uniquely identifying each protocol control circuit 96 to 102 as identification information belonging to the control information attached to a transmitted or received frame and as identification information specific to each protocol control circuit 96 to 102 is assigned to the FC-PH header in the Fibre Channel frame 200.

Specifically speaking, the field 324 of the format 300 is configured as an OX-ID (Originator Exchange IDentifier) and the field 326 is configured as an RX-ID (Responder Exchange IDentifier).

If the frame sender operates as the originator under this circumstance, the exchange number is assigned to “OX-ID” in the field 324; and if the frame sender operates as the responder, the exchange number is assigned to the RX-ID in the field 326. Incidentally, the exchange number is a number including a protocol control circuit number as described later.

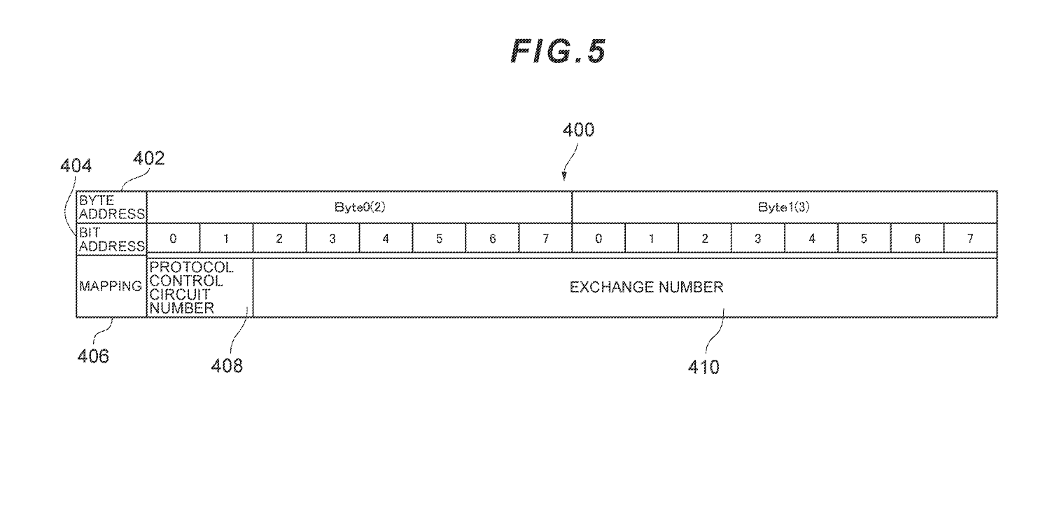

Next, FIG. 5 shows a format configuration diagram of the exchange number.

Referring to FIG. 5, a format 400 of the exchange number is composed of a byte address 402, a bit address 404, and mapping 406. Regarding the byte address 402, “0” to “7” is assigned as the bit address 404 to bytes 0, 1 or bytes 2, 3 respectively. A protocol control circuit number 408 for selecting one protocol control circuit from the four protocol control circuits 96 to 102 is mapped to the first 2 bits of the bit address 404 composed of 16 bits.

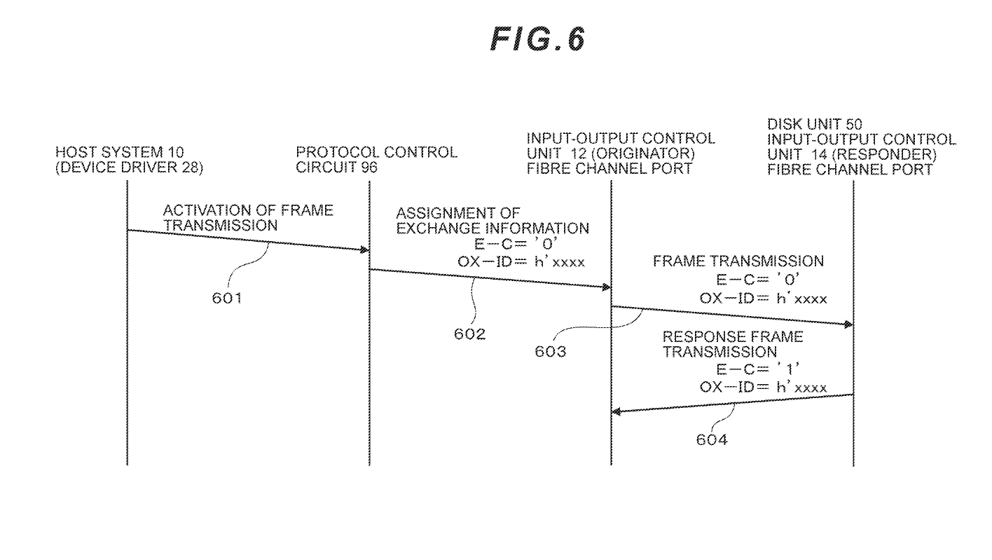

Next, processing executed by the input-output control unit 12 operating as the originator will be explained in accordance with FIG. 6.

When the device driver 28 for the host system 10 executes a transaction and if one protocol control circuit, for example, the protocol control circuit 96 is selected from among the protocol control circuits 96 to 102 and an activation command is sent to the selected protocol control circuit 96, the device driver 28 sends the activation command to the activation queue control circuit 106. The activation queue control circuit 106 stacks a frame transmission activation order as the activation command in the activation queue 116 of the protocol control circuit 96 (601).

The protocol control circuit 96 which has received the frame transmission activation order generates a transmitted frame, sets “0” to the E-C in the field 316 of the transmitted frame, and assigns a unique exchange number (the number including the protocol control circuit number 408 and the exchange number 410) to the OX-ID in the field 324 (602).

Then, the protocol control circuit 96 sends the transmitted frame via the transmission buffer control circuit 88 and the send-data buffer 86 to, for example, the Fibre Channel interface control circuit 78 (603). This transmitted frame is sent from the Fibre Channel interface control circuit 78 via the optical transceiver 70 to the input-output control unit 14 and then to the disk control unit 16.

Subsequently, the disk control unit 16 generates a response frame in response to the transmitted frame. When this happens, the disk control unit 16 operates as the responder, sets “1” to the E-C in the field 316 of the response frame, assigns the same number as the exchange number, which is assigned to the received frame, to the OX-ID in the field 324, and sends the response frame, regarding which the control information is set to each of its fields, to the input-output control unit 14.

The input-output control unit 14 sends the response frame, which has been received from the disk control unit 16, to the input-output control unit 12 (604).

Then, the input-output control unit 12 which has received the response frame processes the response frame as a received frame and executes routing processing for assigning this received frame to one protocol control circuit of the protocol control circuits 96 to 102.

When the unique exchange number (the number for identifying each protocol control circuit 96 to 102) is assigned to the OX-ID in the field 324, for example, the protocol control circuit 96 can assign “00” as a 2-bit number to the protocol control circuit number 408.

Moreover, when the protocol control circuit 98 to 102 assigns the unique exchange number to the OX-ID in the field 324, for example, the protocol control circuit 98 can assign “01” as a 2-bit number to the protocol control circuit number 408, the protocol control circuit 100 can assign “10” as a 2-bit number to the protocol control circuit number 408, and the protocol control circuit 102 can assign “11” as a 2-bit number to the protocol control circuit number 408.

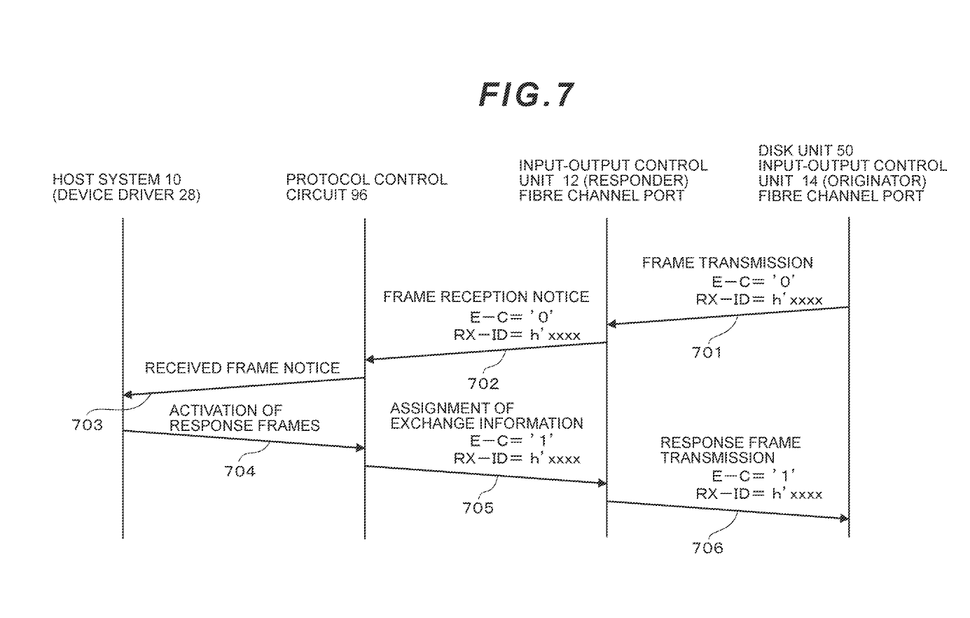

Next, processing executed by the input-output control unit 12 when operating as the responder will be explained with reference to FIG. 7.

Firstly, when the disk control unit 16 operates as the originator, for example, to execute processing different from read processing or write processing, it sets “0” to the E-C in the field 316 of the transmitted frame, sets the exchange number (the number including the protocol control circuit number 408 and the exchange number 410) as control information to the RX-ID in the field 326, and sends the transmitted frame, to which these pieces of control information are set, via the input-output control unit 16 to the input-output control unit 12 (701).

Since “0” is set to the E-C in the field 316 of the received frame, the input-output control unit 12 operates as the responder, identifies the exchange number which is set to the RX-ID in the field 326 of the received frame, and decides a protocol control circuit as the location, to which the received frame should be assigned, based of the above identification result.

For example, the received frame routing control circuit 94 decides, for example, the protocol control circuit 96 as the protocol control circuit to be the location to which the received frame should be assigned, based on the exchange number which is set to the RX-ID in the field 326 of the received frame and notifies the decided protocol control circuit 96 of frame reception (702). Subsequently, the protocol control circuit 96 reports (or sends) the received frame to the device driver 28 for the host system 10 (703).

Next, the device driver 28 for the host system 10 generates a response frame in response to the received frame and sends a response frame activation order for activating the generated response frame to the protocol control circuit 96 (704).

The protocol control circuit 96 sets “1” to the E-C in the field 316 of the response frame and assigns the same exchange number as the exchange number which is set to the received frame (or a new exchange number if no exchange number is set to the received frame) to the RX-ID in the field 326, and sends the response frame, to which these pieces of control information are set, via the transmission buffer control circuit 88 and the send-data buffer 86 to, for example, the Fibre Channel interface control circuit 78 (705).

The Fibre Channel interface control circuit 78 which has received the response frame sends the response frame via the optical transceiver 70 to the input-output control unit 14 (706). Then, the input-output control unit 14 sends the received response frame to the disk control unit 16.

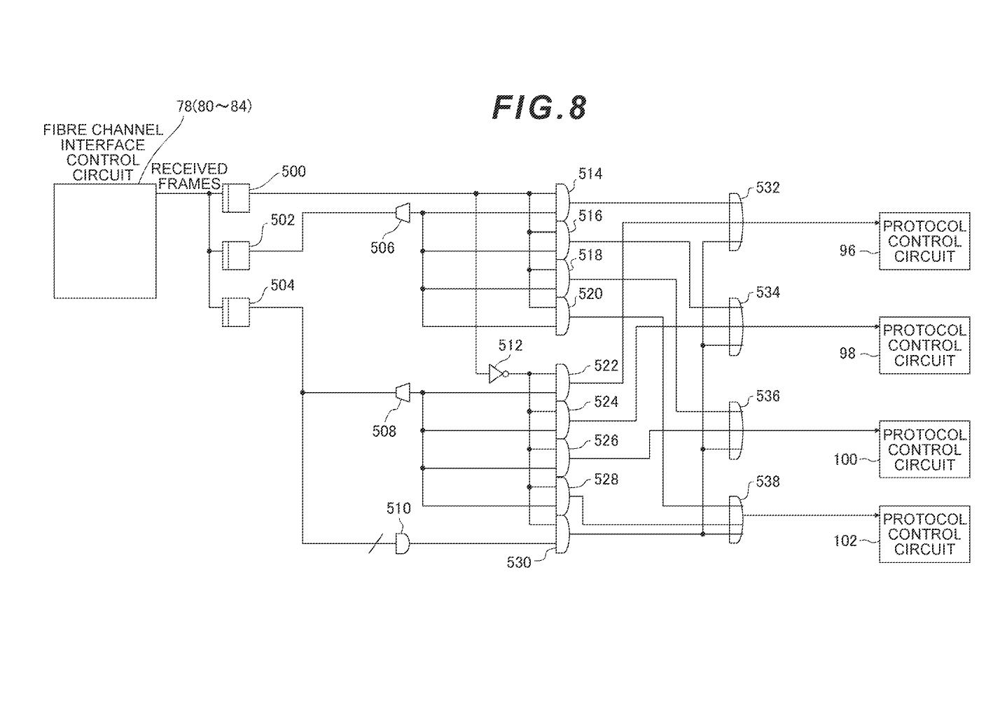

Next, FIG. 8 shows a block diagram of the received frame routing control circuit.

Referring to FIG. 8, the received frame routing control circuit 94 includes registers 500, 502, 504, decoders 506, 508, an AND gate 510, a NOT gate 512, AND gates 514 to 520, AND gates 522 to 530, and OR gates 532, 534, 536, 538; and input sides of the registers 500, 502, 504 are connected respectively to the Fibre Channel interface control circuits 78 to 84 and output sides of the OR gates 532 to 538 are connected respectively to the protocol control circuits 96 to 102.

The register 500 identifies the control information attached to the E-C in the field 316 of the received frame output from the Fibre Channel interface control circuit 78 to 84; and if the E-C is “0,” the register 500 outputs the signal “0” to the AND gates 514 to 520 and converts the signal “0” into signal “1” via the NOT gate 512 and then outputs it to the AND gates 522 to 530.

On the other hand, if the E-C is “1,” the register 500 outputs the signal “1” to the AND gates 514 to 520 and converts the signal “1” into the signal “0” via the NOT gate 512 and then outputs it to the AND gates 522 to 530.

The register 502 identifies control information assigned to the OX-ID in the field 324 of the received frame and outputs a signal indicating the protocol control circuit number 408 in the first 2 bits of this control information to the decoder 506.

The decoder 506 decodes the output signal from the register 502 and then outputs the decoded signal to each of the AND gates 514 to 520.

For example, when signal “00” is input from the register 502, the decoder 506 outputs signal “1000”; when signal “01” is input, the decoder 506 outputs signal “0100”; when signal “10” is input, the decoder 506 outputs signal “0010”; and when signal “11” is input, the decoder 506 outputs signal “0001.”

The AND gates 514 to 520 output a signal, which is subject to the logical AND between the output signal from the register 500 and the output signal from the decoder 506, to the OR gates 532 to 538.

For example, when the input-output control unit 12 operates as the originator and the signal “1” is output from the register 500, the AND gate 514 outputs the signal “1” to the OR gate 532 on condition that signal “1000” is output from the decoder 506; the AND gate 516 outputs the signal “1” to the OR gate 534 on condition that signal “0100” is output from the decoder 506; the AND gate 518 outputs the signal “1” to the OR gate 536 on condition that signal “0010” is output from the decoder 506; and the AND gate 520 outputs the signal “1” to the OR gate 538 on condition that signal “0001” is output from the decoder 506.

On condition that the signal “1” is output from each AND gate 514 to 520, each OR gate 532 to 538 outputs an interrupt signal to the protocol control circuits 96 to 102 to assign the received frame to each protocol control circuit 96 to 102.

When the input-output control unit 12 operates as the originator under this circumstance and if “00” is set to the OX-ID in the field 324 of the received frame, the protocol control circuit 96 is decided as the location to which the received frame should be assigned; if “01” is set to the OX-ID in the field 324, the protocol control circuit 98 is decided as the location to which the received frame should be assigned; if “10” is set to the OX-ID in the field 324, the protocol control circuit 100 is decided as the location to which the received frame should be assigned; and if “11” is set to the OX-ID in the field 324, the protocol control circuit 102 is decided as the location to which the received frame should be assigned.

Specifically, if the protocol control circuit 96 assigns “00” as the protocol control circuit number 408 to the OX-ID in the field 324 of the transmitted frame and similarly the protocol control circuits 98 to 102 assign “01,” “10,” and “11,” respectively, as the protocol control circuit number 408 to the OX-ID in the field 324 of the transmitted frame, each protocol control circuit 96 to 102 will process a response frame, to which the same protocol control circuit number 408 as the protocol control circuit number 408 assigned to the transmitted frame is assigned, as the received frame.

Consequently, even in a case where a plurality of received frames are processed by the input-output control unit 12, it is possible to process a plurality of transactions in parallel by assigning each received frame to each protocol control circuit 96 to 102 in accordance with the protocol control circuit number 408; and as a result, the performance of each transaction can be enhanced.

The register 504 identifies the RX-ID in the field 326 of the received frame, outputs a signal indicating the protocol control circuit number 408 to the decoder 508, and also outputs the signal indicating the protocol control circuit number 408 and a signal indicating the exchange number 410 (signal of 0 to 15 bits) respectively to the AND gate 510.

The decoder 508 decodes an output signal from the register 504 and outputs the decoded signal to the AND gates 522 to 528.

For example, when the register 504 outputs “00,” the decoder 508 outputs signal “1000” to the AND gates 522 to 528; when the register 504 outputs “01,” the decoder 508 outputs signal “0100” to the AND gates 522 to 528; when the register 504 outputs “10,” the decoder 508 outputs signal “0010” to the AND gates 522 to 528; and when the register 504 outputs “1,” the decoder 508 outputs signal “0001” to the AND gates 522 to 528.

The AND gates 522 to 528 output a signal, which is subject to the logical AND between the output signal from the NOT gate 512 and the output signal from the decoder 508, to the OR gates 532 to 538.

For example, on condition that the input-output control unit 12 operates as the responder, the E-C of the received frame is “0,” the signal “0” is output from the register 500, and the NOT gate 512 outputs “1,” the signal “1” is output from the AND gate, to which the signal “1” is input from the decoder 508, among the AND gates 522 to 528.

Specifically speaking, on condition that the NOT gate 512 outputs “1” and if the decoder 508 outputs “1000,” the signal “1” is output from the AND gate 522 to the OR gate 532; if the decoder 508 outputs “0100,” the signal “1” is output from the AND gate 524 to the OR gate 534; if the decoder 508 outputs “0010,” the signal “1” is output from the AND gate 526 to the OR gate 536; and if the decoder 508 outputs “0001,” the signal “1” is output from the AND gate 528 to the OR gate 538.

On condition that the signal “1” is input from the AND gates 522 to 528, the OR gates 532 to 538 output an interrupt signal to the protocol control circuits 96 to 102 to assign the received frame.

When the input-output control unit 12 operates as the responder under this circumstance and if “00” is set to the RX-ID in the field 326 of the received frame, the protocol control circuit 96 is decided as the location to which the received frame should be assigned; if “01” is set to the RX-ID in the field 326, the protocol control circuit 98 is decided as the location to which the received frame should be assigned; if “10” is set to the RX-ID in the field 326, the protocol control circuit 100 is decided as the location to which the received frame should be assigned; and if “11” is set to the RX-ID in the field 326, the protocol control circuit 102 is decided as the location to which the received frame should be assigned.

Consequently, even in a case where a plurality of received frames are processed by the input-output control unit 12, it is possible to process a plurality of transactions in parallel by assigning each received frame to each protocol control circuit 96 to 102 in accordance with the protocol control circuit number 408; and as a result, the performance of each transaction can be enhanced.

Furthermore, if signals, each of which is 0 to 15 bits, and which indicate the protocol control circuit number 408 and the signal indicating the exchange number 410, are “1” respectively, the AND gate 510 outputs the signal “1” to the AND gate 530.

If the signal “1” is output from the AND gate 510 on condition that the NOT gate 512 outputs “1,” the AND gate 530 outputs the signal “1” to all the OR gates 532 to 538.

Specifically, if the signal “1” is output from the AND gate 530, the OR gates 532 to 538 output an interrupt signal to all the protocol control circuits 96 to 102 as the broadcasting processing and decides all the protocol control circuits 96 to 102 to be the locations to which the received frame should be assigned.

In this case, each protocol control circuit 96 to 102 executes the processing on the received frame if the relevant frame is a received frame that the relevant protocol control circuit 96 to 102 should process; and each protocol control circuit 96 to 102 can invalidate the processing on the received frame if the relevant frame is not the received frame that the relevant protocol control circuit 96 to 102 should process.

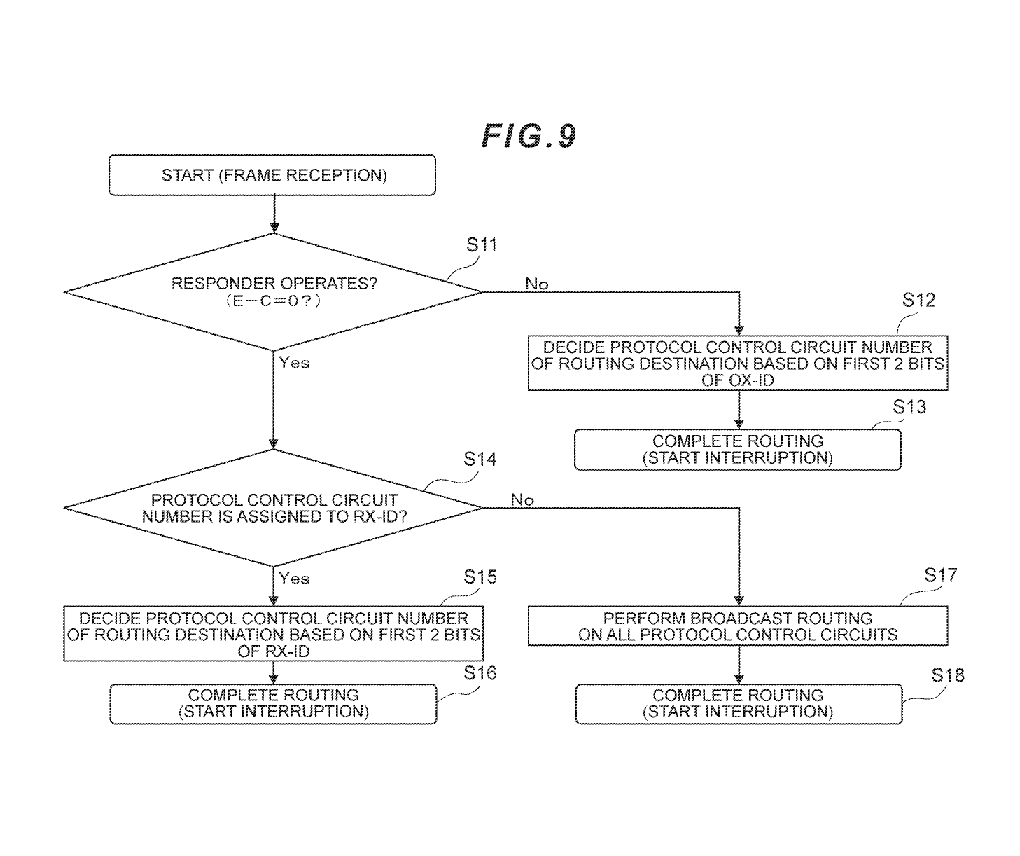

Next, the content of processing executed when the input-output control unit 12 executes the processing on the received frame will be explained in accordance with a flowchart of FIG. 9.

This processing is executed by the received frame routing control circuit 94 as the routing processing after the response frame transmission (604) shown in FIG. 6 or as the routing processing at the time of the frame reception notice (702) in FIG. 7.

The received frame routing control circuit 94 firstly identifies the content of the E-C in the field 316 attached to the received frame and judges whether it is a responder operation or not (S11). If the content of the E-C is not the responder operation, that is, in a case of E-C=1, this means that the input-output control unit 12 operates as an originator, so that the received frame routing control circuit 94 executes processing for deciding the protocol control circuit number of a routing destination based on the protocol control circuit number 408 in first 2 bits in the exchange number assigned to the OX-ID in the field 324 of the received frame (S12).

In this case, the received frame routing control circuit 94 outputs signal “1” from the register 500 and a 2-bit signal indicating the protocol control circuit number 408 from the register 502 to the decoder 506. As a result, an interrupt signal is output to assign the received frame to one protocol control circuit of the protocol control circuits 96 to 102 based on the 2-bit protocol control circuit number 408 and an interrupt is activated (S13), and then the processing in this routine is terminated.

This interrupt processing is executed so that if “00” is set to the OX-ID in the field 324 of the received frame, the protocol control circuit 96 is decided as the location to which the received frame should be assigned; if “01” is set to the OX-ID in the field 324, the protocol control circuit 98 is decided as the location to which the received frame should be assigned; if “10” is set to the OX-ID in the field 324, the protocol control circuit 100 is decided as the location to which the received frame should be assigned; and if “11” is set to the OX-ID in the field 324, the protocol control circuit 102 is decided as the location to which the received frame should be assigned.

On the other hand, if the content of the E-C is determined to be the responder operation in step S11, that is, in a case of E-C=0, the received frame routing control circuit 94 outputs signal “0” from the register 500, and a signal indicating the protocol control circuit number 408 and a signal indicating the exchange number 410, respectively, from the register 504.

If the content of the E-C is determined to be the responder operation in step S11, the received frame routing control circuit 94 judges whether or not the protocol control circuit number 408 is assigned to the RX-ID in the field 326 of the received frame (S14).

If an affirmative judgment result is obtained in step S14, the input-output control unit 12 operates as the responder and thereby executes processing for deciding the protocol control circuit number of the routing destination based on the protocol control circuit number 408 in first 2 bits of the exchange number assigned to the RX-ID in the field 326 of the received frame (S15).

In this case, the received frame routing control circuit 94 outputs the signal “0” from the register 500 and also outputs the 2-bit signal indicating the protocol control circuit number 408 from the register 504 to the decoder 508. As a result, an interrupt signal is output to assign the received frame to any one protocol control circuit of the protocol control circuits 96 to 102 based on the 2-bit protocol control circuit number 408 and an interrupt is activated (S16), and then the processing in this routine is terminated.

This interrupt processing is executed so that if “00” is set to the RX-ID in the field 326 of the received frame, the protocol control circuit 96 is decided as the location to which the received frame should be assigned; if “01” is set to the RX-ID in the field 326, the protocol control circuit 98 is decided as the location to which the received frame should be assigned; if “10” is set to the RX-ID in the field 326, the protocol control circuit 100 is decided as the location to which the received frame should be assigned; and if “11” is set to the RX-ID in the field 326, the protocol control circuit 102 is decided as the location to which the received frame should be assigned.

On the other hand, if a negative judgment result is obtained in step S14, the received frame routing control circuit 94 executes processing for performing broadcasting on all the protocol control circuits 96 to 102 (S17).

Specifically, if identification information for selecting all the protocol control circuits 96 to 102 exists in the control information attached to the received frame, the received frame routing control circuit 94 executes processing for performing broadcasting on all the protocol control circuits 96 to 102.

Specifically speaking, all 16-bit signals output from the register 504 are “1,” the signal “1” is output from the AND gate 510, and the signal “1” is output from the AND gate 530 to all the OR gates 532 to 538, an interrupt is activated on the protocol control circuits 96 to 102 (S18), and then the processing in this routine is terminated.

In this case, each protocol control circuit 96 to 102 executes the processing on the received frame if the relevant frame is a received frame that the relevant protocol control circuit 96 to 102 should process; and each protocol control circuit 96 to 102 invalidates the processing on the received frame if the relevant frame is not the received frame that the relevant protocol control circuit 96 to 102 should process.

According to this embodiment, it is possible to assign a plurality of received frames to a plurality of protocol control units and execute processing on the plurality of received frames in parallel.

Furthermore, even in a case where the processing on a plurality of received frames is executed by the input-output control unit 12, a plurality of transactions can be processed in parallel according to this embodiment by assigning each received frame to each protocol control circuit 96 to 102 in accordance with the protocol control circuit number 408; and as a result, it is possible to enhance the performance of each transaction.

This embodiment has described the case of the input-output control unit 12 which has four protocol control circuits for four Fibre Channel ports; however, the number of protocol control circuits for Fibre Channel ports is not limited to this embodiment. For example, it is possible to configure the input-output control unit 12 which has two or more protocol control circuits for one Fibre Channel port, or the input-output control unit 12 which has two or more protocol control circuits for two or more Fibre Channel ports.

This embodiment has described the case in which the present invention is applied to the computer system with the input-output control units 12, 14 located between the host system 10 and the disk control unit 16; however, the present invention can be also applied to a computer system in which the input-output control unit 12 described in this embodiment is located at the position of the input-output control unit 14 in FIG. 1.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Another configuration can be added to, deleted from, or replaced with part of the configuration of an embodiment.

Furthermore, part or all of the aforementioned configurations, functions, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

10 host system; 12, 14 input-output control units; 16 disk control unit; 28 device driver; 70 to 76 optical transceivers; 78 to 84 Fibre Channel interface control circuits; 86 send-data buffer; 88 transmission buffer control circuit; 90 receive-data buffer; 92 reception buffer control circuit; 94 received frame routing control circuit; 96 to 102 protocol control circuits; 104 DMA control circuit; 106 activation queue control circuit; 108 PCI-express control circuit; 110 serializer/deserializer circuit; 112 frame generation circuit; 114 frame analysis circuit; and 116 activation queue.

1. An input-output control unit comprising:
one or more interface control circuits for sending data to, and receiving data from, an access target of a command issuer via an interface and controlling the data sent to, and received from, the access target of the command issuer on a frame basis with respect to each of transmitted and received frames;
a reception buffer control circuit for storing data of the received frame, from among the transmitted and received frames which are sent and received by the interface control circuit, as receive-data in a receive-data buffer and transferring the receive-data stored in the receive-data buffer to the command issuer;
a transmission buffer control circuit for storing send-data sent from the command issuer in a send-data buffer and transferring the send-data stored in the send-data buffer to the interface;
a plurality of protocol control circuits for controlling the reception buffer control circuit with respect to transfer of the receive-data and controlling the transmission buffer control circuit with respect to transfer of the send-data; and
a received frame routing control circuit for selecting a location to which the received frame should be assigned, from among the plurality of protocol control circuits, based on control information attached to the received frame among the transmitted and received frames, which are sent and received by the interface control circuit, and assigning processing on the received frame to the selected protocol control circuit.

2. The input-output control unit according to claim 1, wherein among the plurality of protocol control circuits, a protocol control circuit which receives an activation command from the command issuer generates control information including identification information specific to the protocol control circuit as the control information attached to a transmitted frame in accordance with the activation command and attaches the generated control information to the send-data stored in the transmission buffer; and
wherein among the plurality of protocol control circuits, a protocol control circuit which is assigned the processing on the received frame by the received frame routing control circuit issues an instruction to the reception buffer control circuit to transfer the receive-data corresponding to the received frame.

3. The input-output control unit according to claim 2, wherein the control information attached to the transmitted frame includes operation information for specifying operation of a sender of the transmitted frame and the identification information specific to the protocol control circuit includes an exchange number for uniquely identifying each protocol control circuit.

4. The input-output control unit according to claim 1, wherein the control information attached to the received frame among the transmitted and received frames sent and received by the interface control circuit is control information attached to a frame generated by the access target of the command issuer and control information including identification information specific to the protocol control circuit.

5. The input-output control unit according to claim 4, wherein the control information attached to the received frame includes operation information for specifying operation of a sender of the received frame and the identification information specific to the protocol control circuit includes an exchange number for uniquely identifying each protocol control circuit.

6. The input-output control unit according to claim 2, wherein the received frame routing control circuit assigns the processing on the received frame to all the protocol control circuits when identification information for selecting all the protocol control circuits exists, as the identification information for identifying the protocol control circuit, in the control information attached to the received frame.

7. The input-output control unit according to claim 1, wherein the receive-data buffer is configured as a receive-data buffer which is common to the plurality of interface control circuits, and the send-data buffer is configured as a send-data buffer which is common to the plurality of interface control circuits.

8. A frame processing method for an input-output control unit including:
one or more interface control circuits for sending data to, and receiving data from, an access target of a command issuer via an interface and controlling the data sent to, and received from, the access target of the command issuer on a frame basis with respect to each of transmitted and received frames;
a reception buffer control circuit for storing data of the received frame, from among the transmitted and received frames which are sent and received by the interface control circuit, as receive-data in a receive-data buffer and transferring the receive-data stored in the receive-data buffer to the command issuer;
a transmission buffer control circuit for storing send-data sent from the command issuer in a send-data buffer and transferring the send-data stored in the send-data buffer to the interface;
a plurality of protocol control circuits for controlling the reception buffer control circuit with respect to transfer of the receive-data and controlling the transmission buffer control circuit with respect to transfer of the send-data; and
a received frame routing control circuit for controlling routing of the received frame among the transmitted and received frames sent and received by the interface control circuit;
the frame processing method comprising:
a step executed by the received frame routing control circuit selecting an location to which the received frame should be assigned, from among the plurality of protocol control circuits, based on control information attached to the received frame; and
a step executed by the received frame routing control circuit assigning processing on the received frame to the selected protocol control circuit.

9. The frame processing method for the input-output control unit according to claim 8, further comprising:
a step executed by a protocol control circuit, which receives an activation command from the command issuer, generating control information including identification information specific to the protocol control circuit as the control information attached to a transmitted frame in accordance with the activation command;
a step executed by the protocol control circuit, which receives the activation command from the command issuer, attaching the generated control information to the send-data stored in the transmission buffer; and
a step executed by the protocol control circuit, which is assigned the processing on the received frame by the received frame routing control circuit, issuing an instruction to the reception buffer control circuit to transfer the receive-data corresponding to the received frame.

10. The frame processing method for the input-output control unit according to claim 8, further comprising a step executed by the received frame routing control circuit assigning the processing on the received frame to all the protocol control circuits when identification information for selecting all the protocol control circuits exists, as the identification information for identifying the protocol control circuit, in the control information attached to the received frame.
